(19) United States
(12) Patent Application Publication
(10) Pub. No.: US 2003/0207014 A1
(43) Pub. Date: Nov. 6, 2003

(54) Animal feed and additive for animal feed to control feed borne pathogens

(76) Inventors: Rene N. Larose, Manchester, CT (US); Robert A. Larose, Marlborough, CT (US)

Correspondence Address: ROBERT S. SMITH, 1131-0 TOLLAND TURNPIKE, SUITE 306, MANCHESTER, CT, 06040, US

(21) Appl. No.: 10/139,188

(22) Filed: May 2, 2002

(51) Int. Cl. A23L 3/34

(52) U.S. Cl. 426/532

(57) ABSTRACT

An additive for animal feed which includes sodium percarbonate. The sodium percarbonate may be in solid form. The invention also includes an animal feed that includes nutritional material and sodium percarbonate. In various forms of the invention the sodium percarbonate constitutes at least 1 percent or at least 2 percent by weight of the entire weight of the animal feed. The animal feed may be in pellet form and the sodium percarbonate may be present in substantially all of the pellets. In some embodiments of the invention the sodium percarbonate constitutes less than 8 percent by weight of the entire weight of said animal feed. Some embodiments of the animal feed in accordance with a present invention do not include any mammalian animal proteins.

### BACKGROUND OF THE INVENTION

The invention relates to animal feeds and additives for animal feeds and particularly to the prevention of feed borne disease resulting from pathogen contamination of animal feeds. World attention has been directed to escalating tragedies such as mad cow disease. An epidemic of this single disease was triggered when scrapy infected sheep were ground together with meal and fed to cows. The epidemic forced the slaughter of thousands of cattle and sheep. The consumption of the animals resulted in human disease and death. The required slaughter of thousands of animals was an economically catastrophic event for many ranchers and farmers. This single disease is merely illustrative of the enormous dangers inherent in food chain contamination. The impact of contaminated food products has enormous economic effects. Concerns about the quality of food products has caused some nations to stop importing food products from specific other countries.

Some feed-borne diseases are well recognized and have become more common due to increases in the consumption of animal products. The more common pathogens, at present, are salmonellosis, escherichia coli serotype 0157:H7 (E. coli), Listeria monocytogenes (Lm), campylobacter jejuni, clostridium perfringens, staphlococcus aureus, bovine spongiform encephalopathy (BSE) also commonly known as mad cow disease, and various fungi such as aspergillus.

Various methods have been used in the attempt to reduce or eliminate the contamination in the feeds. These include heating the feed to sterilizing temperatures, heating to sanitizing temperatures, irradiation, feed additives such as antibiotics (penicillin, streptomycin), chemicals (propionic acid, formaldehyde, sodium benzoate). Most of these measures have some degree of success, limited by high costs, narrow spectrum of effectiveness, and/or undesirable side effects. Giving animals antibiotics in their feed causes microbes in the livestock to become resistant to the drugs. People can then become infected with a resistant bacteria by eating or handling meat contaminated with the pathogens. Accordingly, the antibiotics widely used on farm animals diminish the power of important antibiotics to help people.

### SUMMARY OF THE INVENTION

It is an object of the present invention to provide an animal feed as well as an additive for an animal feed that will substantially control all known pathogens.

Another object the present invention is to provide an animal feed that is not toxic to the animal consuming the feed or to any other human or animal in the subsequent food chain.

Still another object invention is to provide an animal feed as well as an additive for an animal feed that is readily available and inexpensive.

Yet another object invention is to provide an animal feed as well as an additive for animal feed that is non-mutagenic and does not contribute to environmental contamination.

It has now been found that these and other objects of the invention may be attained in an additive for animal feed which includes sodium percarbonate. The sodium percarbonate may be in solid form.

These and other objects of the invention may also be attained in animal feed which includes nutritional material and sodium percarbonate. In various forms of the invention the sodium percarbonate constitutes at least 1 percent or at least 2 percent by weight of the entire weight of the animal feed. The animal feed may be in pellet form and the sodium percarbonate may be present in substantially all of the pellets. In some embodiments of the invention the sodium percarbonate constitutes less than 8 percent by weight of the entire weight of said animal feed. Some embodiments of the animal feed in accordance with a present invention do not include any mammalian animal proteins.

### DESCRIPTION OF THE PREFERRED EMBODIMENTS

The animal kingdom is one of two generally accepted major divisions of living organisms which live or have lived on earth. (The other division being the plant kingdom). Animals within the food chain vary in different countries and different societies. Animals within the food chain include, but are not limited to, cattle, pigs, sheep, goats, rabbits, and chickens, turkeys, ducks, fish and the like. Although the present invention has particular application to animal feed for animals within the food chain for humans, the invention will be understood to also have application to animals that are not ordinarily considered to be within the food chain for humans. For example, just as the food products ingested by a human being have a marked impact on the health of the human the food products ingested by other members of the animal kingdom are also substantially affected by the food products that they ingest. Thus, the invention also has application to food products for animals that include, but are not limited to horses, household pets, wild birds, wild squirrels, wild deer and the like.

The specific feed for a given animal will vary. Common nutrient constituents of animal feed products include soya meal, maize gluten, and grains. Some animal feeds in accordance with some forms of the present invention may even include genetically modified grains, antibiotics and irradiated nutrients.

Sodium percarbonate, also known as sodium peroxyhydrate, has been proven itself to be powerful oxidizer, totally non-toxic, yet capable of oxidizing microbes without leaving a residue and breaking down into oxygen and carbon dioxide. As used herein the term “control of pathogens” means a reduction in the overall population of such pathogens. Sodium percarbonate is a white non-toxic crystalline powder, slightly alkaline, very soluble in water, odorless, and very stable under pressure steam sterilization.

These properties make sodium percarbonate an ideal feed additive for animal feeds. In the preferred embodiments of the present invention sodium percarbonate is included in the feed formulations prior to the pellet forming process common to most animal feed processing procedures. Incorporating the sodium percarbonate in feed does not change the feed characteristics and is undetectable visually or otherwise. Furthermore, laboratory tests have indicated that the percarbonate is a very powerful anti-microbial agent effective against all microbes present in animal feeds. This is due to the broad disinfection action of the sodium percarbonate upon all bacteria and the spores of bacteria, fungi, and algae.

Although the percarbonate is an extremely active chemical, the treated feed is readily accepted by livestock and presents no untold digestive reactions when tested in poultry at rates of 2-8% by weight. The preferred proportion of sodium percarbonate will vary for the specific animal feed composition and the specific animal consuming the feed as well as various environmental factors. Testing indicates that sodium percarbonate is the best tool to date for the prevention of feed-borne pathogens that are presently rampant in the agricultural feeds.

Testing has indicated that the effectiveness of sodium percarbonate is greatest in animal feeds that do not include mammalian animal proteins. Accordingly, the preferred embodiments of the invention do not include such proteins. Such mammalian animal proteins have been banned throughout Europe although they continue to be used in other parts of the world. Otherwise the animal feeds in accordance with present invention are substantially the same as conventional animal feeds with the addition of sodium percarbonate.

The invention has been described with reference to the preferred embodiment. Persons skilled in the art of such inventions may upon exposure to the teachings herein, conceive other variations such variations are deemed to be encompassed by the disclosure, the invention being delimited only by the following claims.

Having thus described my invention I claim:

1. An additive for animal feed which comprises:
sodium percarbonate.

2. The additive in accordance with claim 1 wherein:
said sodium percarbonate is in a solid form.

3. An animal feed which comprises:
nutritional material and
sodium percarbonate.

4. The animal feed in accordance with claim 3 wherein:
the sodium percarbonate constitutes at least 1 percent by weight of the entire weight of said animal feed.

5. The animal feed in accordance with claim 4 wherein:
said animal feed is in pellet form.

6. The animal feed in accordance with claim 5 wherein:
said sodium percarbonate is present in substantially all of said pellets.

7. The animal feed in accordance with claim 3 wherein:
said sodium percarbonate constitutes at least 2 percent by weight of the entire weight of said animal feed.

8. The animal feed in accordance with claim 7 wherein:
said animal feed is in pellet form.

9. The animal feed in accordance with claim 8 wherein:
said sodium percarbonate is present in substantially all of said pellets.

10. The animal feed in accordance with claim 3 wherein:
said sodium percarbonate constitutes less than 8 percent by weight of the entire weight of said animal feed.

11. The animal feed in accordance with claim 10 wherein:
said animal feed does not include any mammalian animal proteins.

12. The animal feed in accordance with claim 3 wherein:
said animal feed does not include any mammalian animal proteins.

13. The animal feed in accordance with claim 7 wherein:
said animal feed does not include any mammalian animal proteins.

14. The animal feed in accordance with claim 8 wherein:
said animal feed does not include any mammalian animal proteins.

15. The animal feed in accordance with claim 11 wherein:
said sodium percarbonate is present in substantially all of said pellets.
